(19) United States
(12) Patent Application Publication
(10) Pub. No.: US 2022/0108860 A1
(43) Pub. Date: Apr. 7, 2022

(54) RELAY

(71) Applicant: OMRON Corporation, Kyoto-shi, Kyoto (JP)

(72) Inventors: Koichiro MATSUSHIMA, Kikuchi-gun, Kumamto (JP); Ayaka MIYAKE, Kikuchi-shi, Kumamto (JP); Yuji KOZAI, Kyoto-shi, Kyoto (JP); Taira MINAMIZAKI, Koshi-shi, Kumamoto (JP)

(21) Appl. No.: 17/429,628

(22) PCT Filed: Feb. 12, 2020
(86) PCT No.: PCT/JP2020/005226

§ 371 Date: Aug. 10, 2021

(30) Foreign Application Priority Data
Feb. 20, 2019 (JP) 2019-028888

(51) Int. Cl. H01H 50/58; H01H 50/02; H01H 50/20; H01H 50/64; H01H 50/44

(52) U.S. Cl. CPC H01H 50/58; H01H 50/02; H01H 2050/446; H01H 50/64; H01H 50/44; H01H 50/20

(57) ABSTRACT

A relay includes a first fixed terminal, a first fixed contact, a second fixed terminal, a second fixed contact, a first movable contact piece, a first movable contact, a second movable contact, an insulating member, and a drive device. The first fixed contact is connected to the first fixed terminal. The second fixed contact is connected to the second fixed terminal. The first movable contact and the second movable contact are connected to the first movable contact piece. The insulating member is connected to the first movable contact piece. The drive device includes a coil and a movable iron core. The movable iron core is connected to the insulating member. The drive device moves the movable iron core by a magnetic force generated from the coil to move the movable contact piece. The first movable contact piece and the movable iron core are electrically insulated by the insulating member.

### CROSS-REFERENCE TO RELATED APPLICATION

This application is the U.S. National Phase of International Application No. PCT/JP2020/005226, filed on Feb. 12, 2020. This application claims priority to Japanese Patent Application No. 2019-028888, filed Feb. 20, 2019. The contents of those applications are incorporated by reference herein in their entireties.

### FIELD

The present invention relates to a relay.

### BACKGROUND

A plunger type relay includes a pair of fixed contacts, a movable contact piece, and a drive device. For example, in the relay of Japan Laid-open Patent Application Publication No. 2017-204480, the movable contact piece has a pair of movable contacts. The pair of movable contacts are arranged apart from each other in a longitudinal direction of the movable contact piece. The pair of movable contacts are respectively arranged to face the pair of fixed contacts.

The drive device moves the movable contact piece. The drive device includes a coil and a movable iron core. The movable contact piece is connected to the movable iron core via a drive shaft. The movable contact piece moves as the movable iron core moves by a magnetic force generated from the coil.

### SUMMARY

In the relay described above, the movable contact piece and the movable iron core are connected by the drive shaft made of a conductive material. Therefore, it is difficult to secure an insulation distance between the movable contact piece and the movable iron core. Further, if an insulating member is arranged between the movable contact piece and the drive shaft in order to secure the insulation distance, the relay becomes large.

An object of the present invention is to secure an appropriate insulation distance for a movable contact piece while suppressing enlargement of a relay.

A relay according to one aspect of the present invention includes a first fixed terminal, a first fixed contact, a second fixed terminal, a second fixed contact, a first movable contact piece, a first movable contact, a second movable contact, an insulating member, and a drive device. The first fixed contact is connected to the first fixed terminal. The second fixed contact is connected to the second fixed terminal. The first movable contact is connected to the first movable contact piece and faces the first fixed contact. The second movable contact is connected to the first movable contact piece and faces the second fixed contact. The insulating member is connected to the first movable contact piece. The drive device includes a spool, a coil, and a movable iron core. The coil is wound around the spool. At least a part of the movable iron core is arranged in the spool. The movable iron core is connected to the insulating member. The drive device moves the movable iron core by a magnetic force generated from the coil to move the movable contact piece. The first movable contact piece and the movable iron core are electrically insulated by the insulating member.

In the relay according to the present aspect, the first movable contact piece and the movable iron core are connected by the insulating member. Further, the first movable contact piece and the movable iron core are electrically insulated by the insulating member. Therefore, it is possible to secure an appropriate insulation distance for the first movable contact piece while suppressing enlargement of the relay.

The insulating member may be fixed to the movable iron core so as to be immovable relative to the movable iron core in a moving direction of the first movable contact piece. In this case, the movable iron core can stably hold the insulating member.

The insulating member may be fixed to the movable iron core so as to be non-rotatable relative to the movable iron core around an axis extending in the moving direction of the first movable contact piece. In this case, the movable iron core can stably hold the insulating member.

The insulating member may include a first flat surface and a second flat surface extending in the moving direction of the first movable contact piece. The movable iron core may include a third flat surface and a fourth flat surface extending in the moving direction of the first movable contact piece. The first flat surface may contact the third flat surface. The second flat surface may contact the fourth flat surface. In this case, the movable iron core can stably hold the insulating member since the flat surfaces contact each other.

The movable iron core may include a plurality of plate members that are provided separately from each other. In this case, a processing cost of the movable iron core can be reduced.

The plurality of plate members may be laminated and integrated with each other. In this case, the processing cost of the movable iron core can be reduced.

The movable iron core may have a non-circular shape in a cross section perpendicular to the moving direction of the movable contact piece. In this case, the movable iron core can be easily manufactured.

The movable iron core may have a prismatic shape. In this case, the movable iron core can be easily manufactured.

The relay may further include a housing. The housing may slidably support the insulating member. In this case, the insulating member can be moved stably.

The insulating member may include a protrusion that projects towards the housing. The housing may slidably support the insulating member at the protrusion. In this case, wear debris generated from the insulating member and/or the housing can be reduced.

The housing may include a recess that contacts the protrusion. In this case, the wear debris is retained in the recess. As a result, it is possible to prevent the wear debris from diffusing into the housing.

The housing may include a base that supports the drive device. The base may slidably support the insulating member. In this case, the insulating member can stably move by the base.

The relay may further include a first return spring and a second return spring. The first return spring and the second return spring may contact the insulating member. The first return spring and the second return spring may press the insulating member in a direction in which the first movable contact and the second movable contact are separated from the first fixed contact and the second fixed contact. In this case, the first return spring and the second return spring press the insulating member and thereby the contacts can be returned to an open state.

The insulating member may include a link part, a first connection part, and a second connection part. The link part may be connected to the movable iron core. The first connection part may be connected to the link part and the first return spring may be connected to the first connection part. The second connection part may be connected to the link part and the second return spring may be connected to the second connection par part. In this case, the contacts can be stably returned to the open state by the first return spring and the second return spring.

The relay may further include a third fixed contact, a fourth fixed contact, a second movable contact piece, a third movable contact, and a fourth movable contact. The third fixed contact may be connected to the first fixed terminal. The fourth fixed contact may be connected to the second fixed terminal. The second movable contact piece may be provided separately from the first movable contact piece. The third movable contact may be connected to the second movable contact piece and face the third fixed contact. The fourth movable contact may be connected to the second movable contact piece and face the fourth fixed contact. The insulating member may be connected to the first movable contact piece and the second movable contact piece. The first movable contact piece and the movable iron core may be electrically insulated by the insulating member. The second movable contact piece and the movable iron core may be electrically insulated by the insulating member.

In this case, a current is divided into the first movable contact and the third movable contact. The current is divided into the second movable contact and the fourth movable contact. Thereby, a contact resistance of the relay and temperature rise can be reduced. Further, the first movable contact piece and the second movable contact piece are provided separately from each other. Therefore, as compared with a case where the first to fourth movable contacts are provided on an integrated movable contact piece, the first to fourth movable contacts can stably contact the first to fourth fixed contacts, respectively. Further, the appropriate insulation distance can be secured between the first movable contact piece and the movable iron core and between the second movable contact piece and the movable iron core.

### BRIEF DESCRIPTION OF THE DRAWINGS

FIG. 1 is a perspective view of a relay according to an embodiment.

FIG. 2 is a perspective view of the relay.

FIG. 3 is an exploded perspective view of the relay.

FIG. 4 is a side view of the relay.

FIG. 5 is a front view of the relay.

FIG. 6 is an enlarged view of an insulating member.

FIG. 7 is an enlarged view of the insulating member and a movable contact piece.

FIG. 8 is a front sectional view of the relay.

FIG. 9 is an enlarged front sectional view of the relay.

FIG. 10 is a top sectional view of the relay.

FIG. 11 is a top sectional view of the relay.

FIG. 12 is an enlarged view of a link part of the insulating member and a link part of a movable iron core.

### DETAILED DESCRIPTION

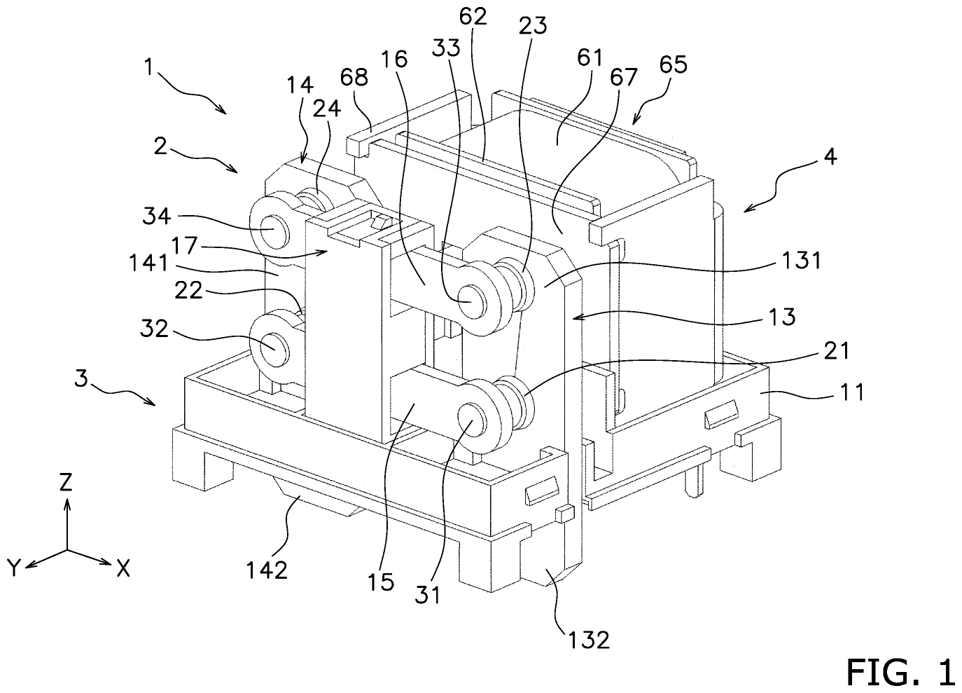

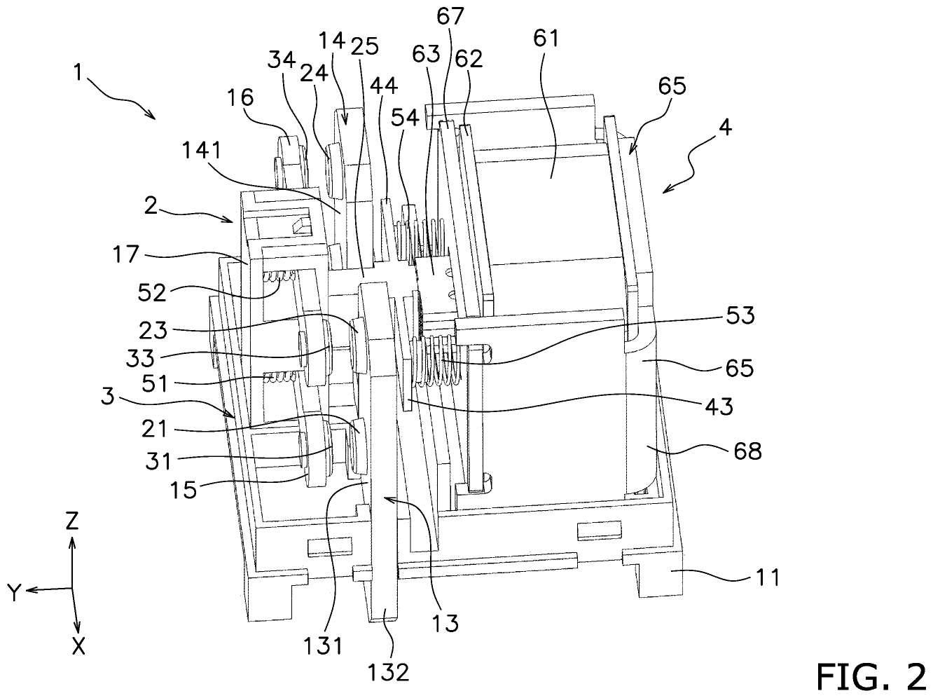

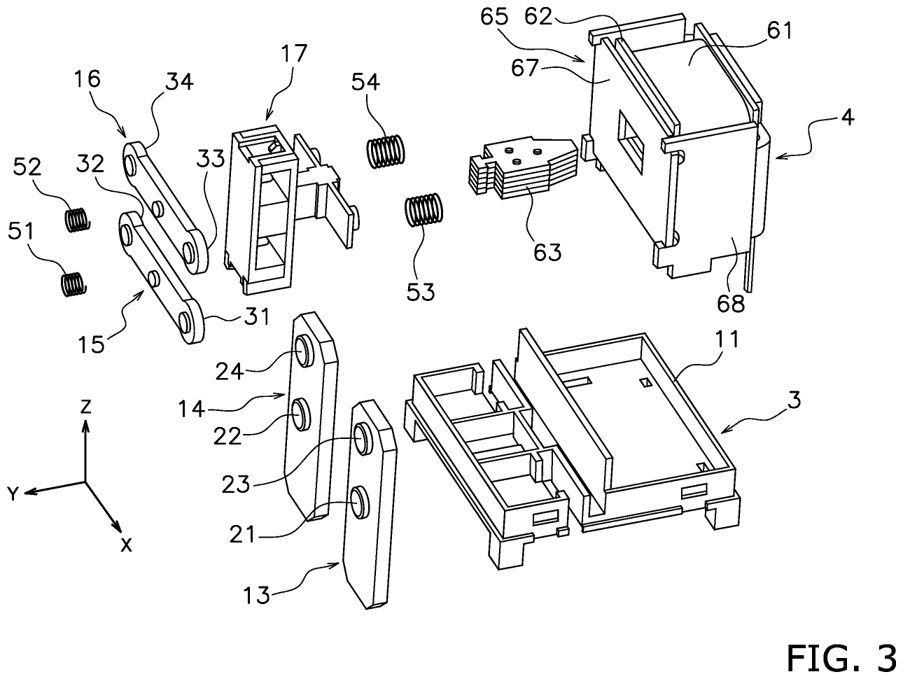

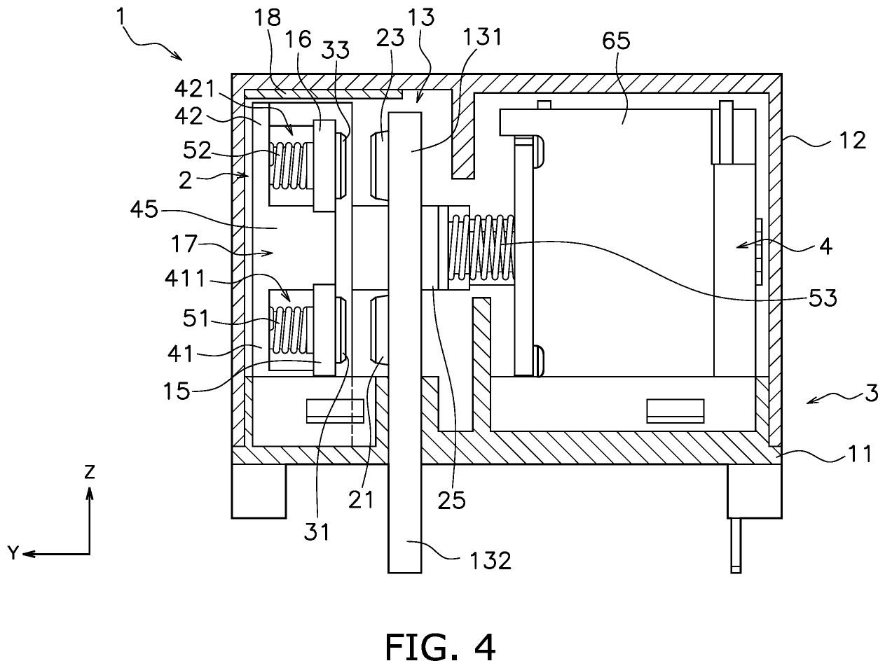

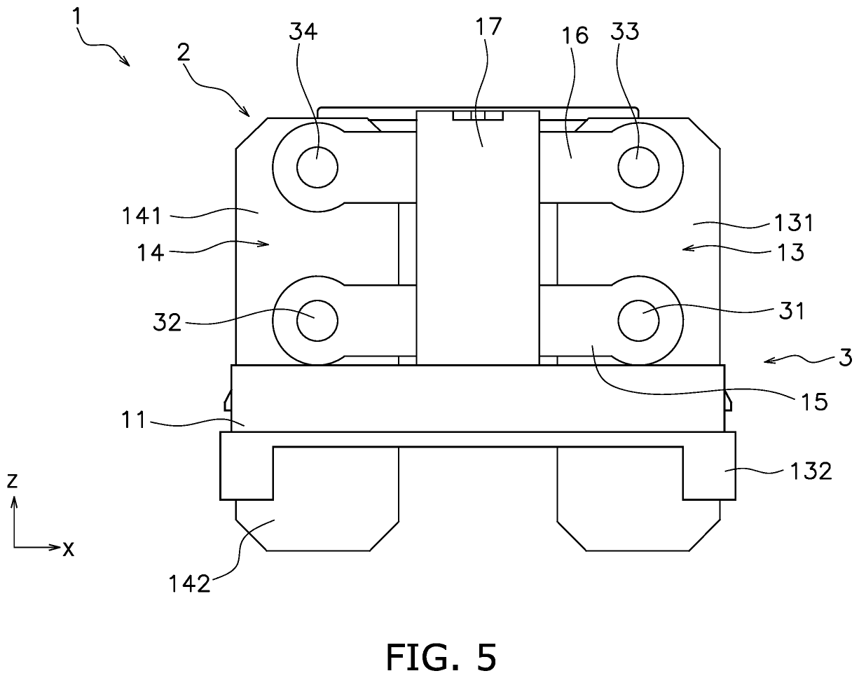

Hereinafter, a relay 1 according to an embodiment will be described with reference to the drawings. FIGS. 1 and 2 are perspective views of the relay 1 according to the embodiment. FIG. 3 is an exploded perspective view of the relay 1. FIG. 4 is a side view of the relay 1. FIG. 5 is a front view of the relay 1.

As illustrated in FIGS. 1 to 5, the relay 1 includes a contact device 2, a housing 3, and a drive device 4. The contact device 2 and the drive device 4 are arranged in the housing 3. The housing 3 includes a base 11 and a case 12 illustrated in FIG. 4. The base 11 and the case 12 are made of, for example, resin. In FIG. 4, the base 11 and the case 12 are illustrated in cross section. In FIGS. 1 to 3 and 5, the case 12 is omitted.

In the following description, a direction in which the contact device 2 and the drive device 4 are arranged with respect to the base 11 is defined as upward, and the opposite direction is defined as downward. Further, a direction that intersects the vertical direction (Z) is defined as a front-rear direction (Y). A direction that intersects the vertical direction (Z) and the front-rear direction (Y) is defined as a left-right direction (X). The left-right direction (X) is an example of the first direction. The vertical direction (Z) is an example of the second direction. However, these directions are defined for convenience of explanation, and do not limit the arrangement direction of the relay 1.

The contact device 2 includes a first fixed terminal 13, a second fixed terminal 14, a first fixed contact 21, a second fixed contact 22, a third fixed contact 23, and a fourth fixed contact 24. The first fixed terminal 13 and the second fixed terminal 14 are made of a conductive material such as copper. The first fixed terminal 13 and the second fixed terminal 14 extend in the vertical direction (Z), respectively. The first fixed terminal 13 and the second fixed terminal 14 are arranged apart from each other in the left-right direction (X). The first fixed terminal 13 and the second fixed terminal 14 are supported by the base 11.

The first fixed terminal 13 includes a first contact support part 131 and a first outer terminal part 132. The second fixed terminal 14 includes a second contact support part 141 and a second outer terminal part 142. The first contact support part 131 and the second contact support part 141 are arranged in the housing 3. The first outer terminal part 132 and the second outer terminal part 142 project outward from the housing 3. The first outer terminal part 132 and the second outer terminal part 142 project downward from the base 11.

The first fixed contact 21 and the third fixed contact 23 are connected to the first contact support part 131. The first fixed contact 21 and the third fixed contact 23 are provided separately from the first fixed terminal 13. The first fixed contact 21 and the third fixed contact 23 are arranged apart from each other in the vertical direction (Z) on the first fixed terminal 13.

The second fixed contact 22 and the fourth fixed contact 24 are arranged apart from the first fixed contact 21 and the third fixed contact 23 in the left-right direction (X). The second fixed contact 22 and the fourth fixed contact 24 are connected to the second contact support part 141. The second fixed contact 22 and the fourth fixed contact 24 are provided separately from the second fixed terminal 14. The second fixed contact 22 and the fourth fixed contact 24 are arranged apart from each other in the vertical direction (Z) on the second fixed terminal 14. The first to fourth fixed contacts 21 to 24 are made of a conductive material such as silver or copper.

The contact device 2 includes a first movable contact piece 15, a second movable contact piece 16, a first movable contact 31, a second movable contact 32, a third movable contact 33, and a fourth movable contact 34. The first movable contact piece 15 and the second movable contact piece 16 extend in the left-right direction (X). The longitudinal direction of the first movable contact piece 15 and the second movable contact piece 16 coincides with the left-right direction (X). The first movable contact piece 15 and the second movable contact piece 16 are provided separately from each other. The first movable contact piece 15 and the second movable contact piece 16 are arranged apart from each other in the vertical direction (Z).

The second movable contact piece 16 is arranged above the first movable contact piece 15. The first movable contact piece 15 is arranged between the second movable contact piece 16 and the base 11 in the vertical direction (Z). The first movable contact piece 15 and the second movable contact piece 16 are arranged to face the first contact support part 131 of the first fixed terminal 13 and the second contact support part 141 of the second fixed terminal 14 in the front-rear direction (Y). The first movable contact piece 15 and the second movable contact piece 16 are made of a conductive material such as copper.

The first movable contact 31 and the second movable contact 32 are provided separately from the first movable contact piece 15. The first movable contact 31 and the second movable contact 32 are connected to the first movable contact piece 15. The first movable contact 31 and the second movable contact 32 are arranged apart from each other in the left-right direction (X). The first movable contact 31 is arranged to face the first fixed contact 21. The second movable contact 32 is arranged to face the second fixed contact 22.

The third movable contact 33 and the fourth movable contact 34 are provided separately from the second movable contact piece 16. The third movable contact 33 and the fourth movable contact 34 are connected to the second movable contact piece 16. The third movable contact 33 and the fourth movable contact 34 are arranged apart from each other in the left-right direction (X). The third movable contact 33 is arranged apart from the first movable contact 31 in the vertical direction (Z). The fourth movable contact 34 is arranged apart from the second movable contact 32 in the vertical direction (Z). The third movable contact 33 is arranged to face the third fixed contact 23. The fourth movable contact 34 is arranged to face the fourth fixed contact 24. The first to fourth movable contacts 31 to 34 are made of a conductive material such as silver or copper.

The contact device 2 includes an insulating member 17. The insulating member 17 is connected to the first movable contact piece 15 and the second movable contact piece 16. The first movable contact piece 15 is connected to the insulating member 17 between the first movable contact 31 and the second movable contact 32. The second movable contact piece 16 is connected to the insulating member 17 between the third movable contact 33 and the fourth movable contact 34. The insulating member 17 is made of an insulating material such as resin.

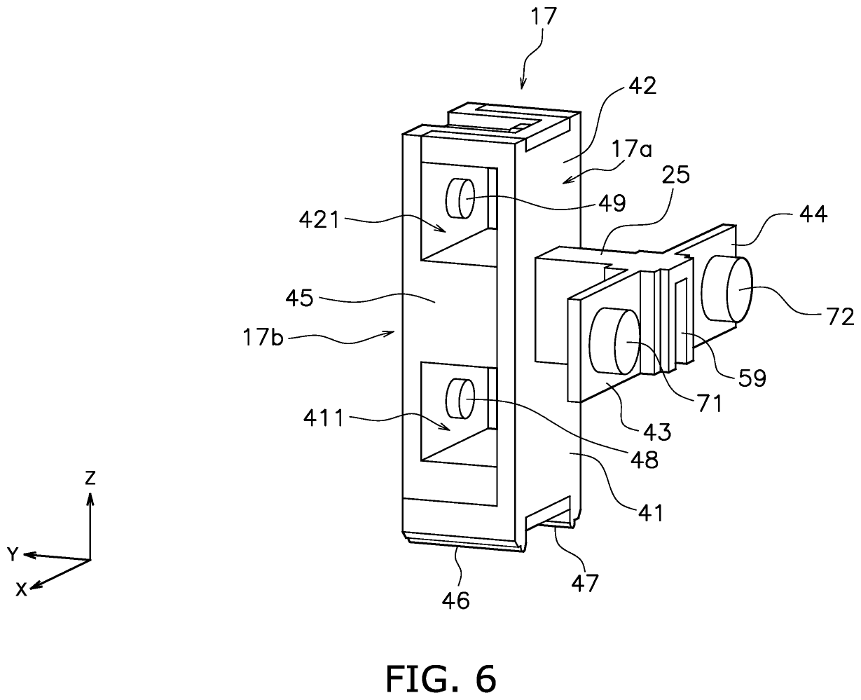

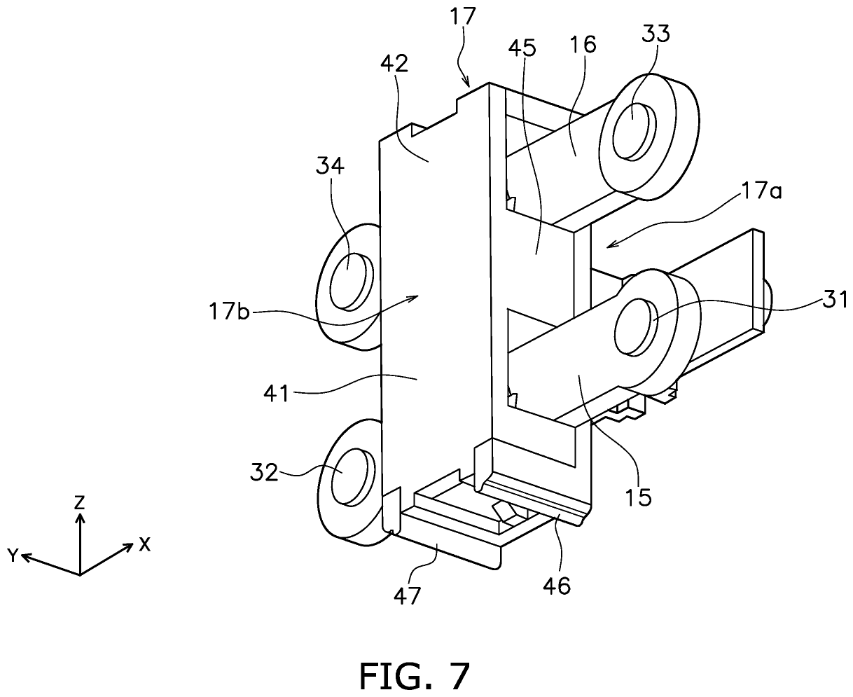

In detail, FIGS. 6 and 7 are enlarged views of the insulating member 17. As illustrated in FIG. 6, the insulating member 17 includes a link part 25, a first support part 41, a second support part 42, a first connection part 43, and a second connection part 44. The link part 25 extends in the front-rear direction (Y). The first support part 41 extends downward from the link part 25. The first support part 41 supports the first movable contact piece 15. The first support part 41 includes a first support hole 411. The first movable contact piece 15 is arranged in the first support hole 411.

The second support part 42 extends upward from the link part 25. The second support part 42 supports the second movable contact piece 16. The second support part 42 includes a second support hole 421. The second movable contact piece 16 is arranged in the second support hole 421. The insulating member 17 includes a partition wall 45. The partition wall 45 partitions the first support hole 411 and the second support hole 421. The partition wall 45 is arranged between the first movable contact piece 15 and the second movable contact piece 16.

As illustrated in FIG. 6, the insulating member 17 includes a first member 17a and a second member 17b. The first member 17a and the second member 17b are provided separately from each other. The first member 17a and the second member 17b are connected to each other by snap fit. The first member 17a includes the link part 25, a part of the first support part 41, a part of the second support part 42, the first connection part 43, and the second connection part 44. The second member 17b includes a part of the first support part 41 and a part of the second support part 42. The first support hole 411 and the second support hole 421 are provided between the first member 17a and the second member 17b.

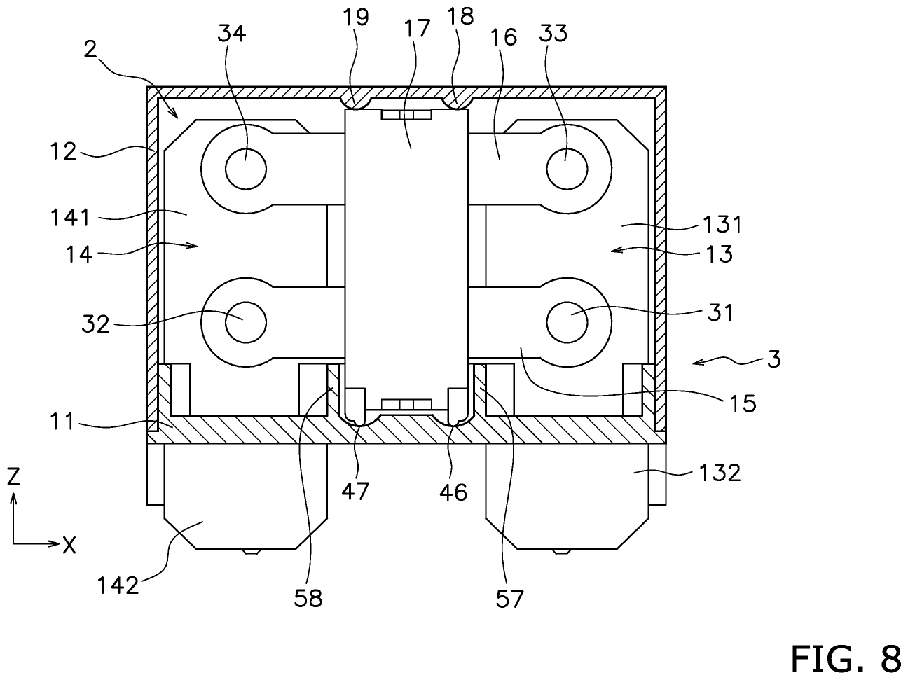

FIG. 8 is a front sectional view of the relay 1. As illustrated in FIGS. 4 and 8, an upper end of the insulating member 17 is arranged close to the case 12. A top surface of the case 12 includes support protrusions 18 and 19. The support protrusions 18 and 19 project from the top surface of the case 12 toward the upper end of the insulating member 17. Specifically, the support protrusions 18 and 19 include a first support protrusion 18 and a second support protrusion 19. The first support protrusion 18 and the second support protrusion 19 extend in the front-rear direction (Y), respectively. The first support protrusion 18 and the second support protrusion 19 are arranged apart from each other in the left-right direction (X).

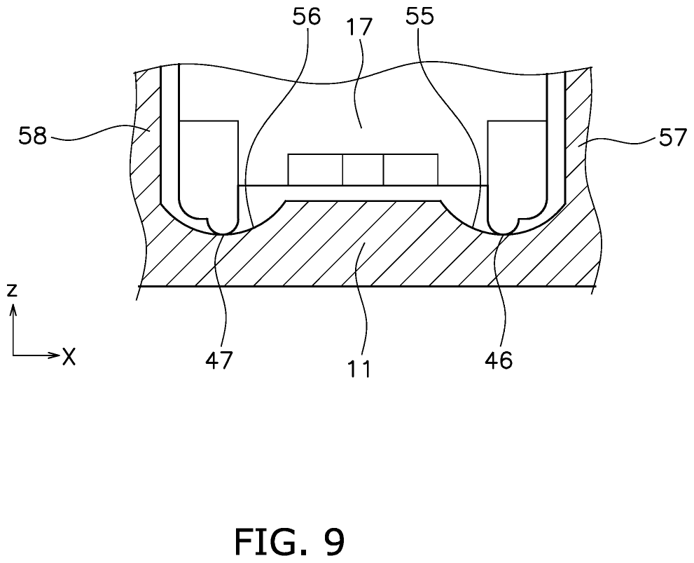

A lower end of the insulating member 17 is arranged on the base 11. The insulating member 17 is slidably supported by the base 11 in the vertical direction (Z). FIG. 9 is an enlarged view of the lower end of the insulating member 17 and the base 11. Specifically, as illustrated in FIGS. 7 to 9, a bottom surface of the insulating member 17 includes protrusions 46 and 47. The protrusions 46 and 47 project toward the base 11. The protrusions 46 and 47 include a first protrusion 46 and a second protrusion 47. The first protrusion 46 and the second protrusion 47 extend in the front-rear direction (Y), respectively. The first protrusion 46 and the second protrusion 47 are arranged apart from each other in the left-right direction (X).

The base 11 slidably supports the insulating member 17 at the first protrusion 46 and the second protrusion 47. As illustrated in FIG. 9, the base 11 includes a first recess 55 and a second recess 56. The first recess 55 and the second recess 56 have a smoothly curved shape. The first recess 55 is arranged below the first protrusion 46. The first recess 55 contacts the first protrusion 46. The first recess 55 slidably supports the first protrusion 46. The second recess 56 is arranged below the second protrusion 47. The second recess 56 contacts the second protrusion 47. The second recess 56 slidably supports the second protrusion 47.

As illustrated in FIG. 8, the base 11 include a first guide wall 57 and a second guide wall 58. The first guide wall 57 and the second guide wall 58 project upward from the base 11. The first guide wall 57 and the second guide wall 58 extend in the front-rear direction (Y). The lower end of the insulating member 17 is arranged between the first guide wall 57 and the second guide wall 58.

The contact device 2 includes a first contact spring 51 and a second contact spring 52. The first contact spring 51 is arranged between the first movable contact piece 15 and the first support part 41. The first contact spring 51 is arranged in the first support hole 411. As illustrated in FIG. 6, the insulating member 17 includes a first spring support part 48. The first spring support part 48 projects into the first support hole 411. The first contact spring 51 is supported by the first spring support part 48. In a state where the first movable contact 31 contacts the first fixed contact 21 and the second movable contact 32 contacts the second fixed contact 22, the first contact spring 51 presses the first movable contact piece 15 toward the first fixed terminal 13 and the second fixed terminal 14.

The second contact spring 52 is arranged between the second movable contact piece 16 and the second support part 42. The second contact spring 52 is arranged in the second support hole 421. The insulating member 17 includes a second spring support part 49. The second spring support part 49 projects into the second support hole 421. The second contact spring 52 is supported by the second spring support part 49. In a state where the third movable contact 33 contacts the third fixed contact 23 and the fourth movable contact 34 contacts the fourth fixed contact 24, the second contact spring 52 presses the second movable contact piece 16 toward the first fixed terminal 13 and the second fixed terminal 14.

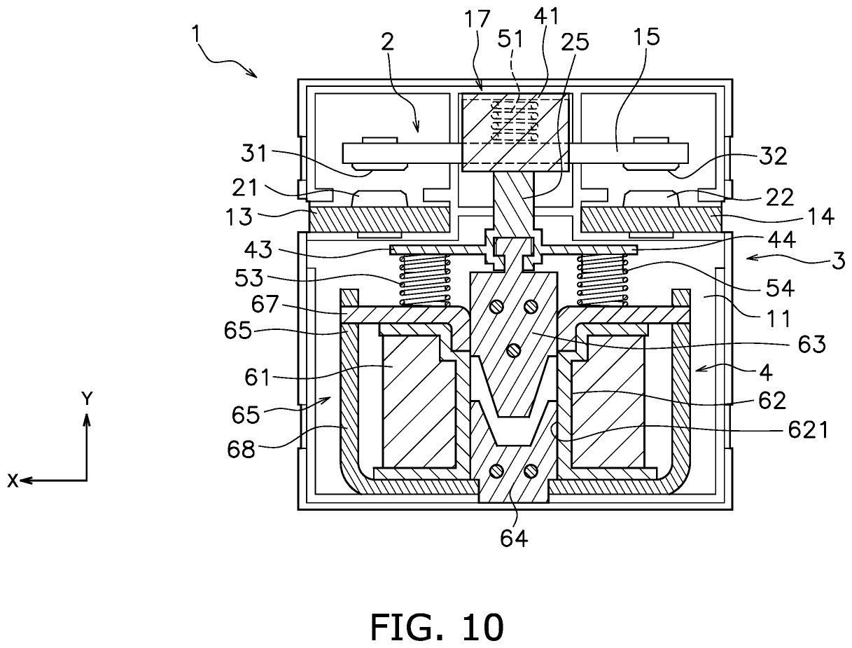

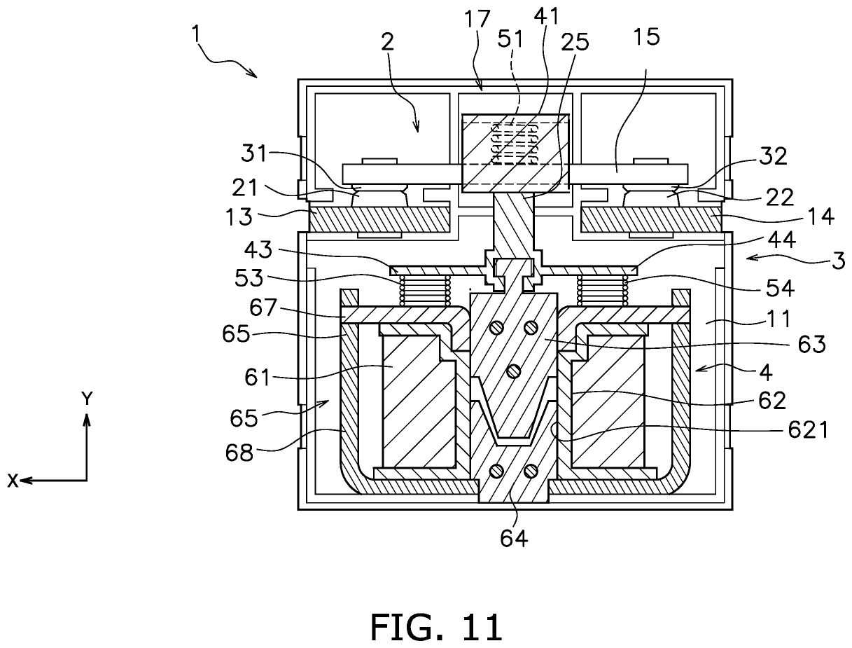

FIGS. 10 and 11 are top sectional views of the relay 1. The drive device 4 operates the first movable contact piece 15 and the second movable contact piece 16 by an electromagnetic force. The drive device 4 operates the first movable contact piece 15 and the second movable contact piece 16 in a contact direction and an opening direction. The contact direction is a direction in which the movable contacts 31 to 34 approach the fixed contacts 21 to 24 in the front-rear direction (Y). The opening direction is a direction in which the movable contacts 31 to 34 are separated from the fixed contacts 21 to 24 in the front-rear direction (Y). The drive device 4 includes a coil 61, a spool 62, a movable iron core 63, a fixed iron core 64, and a yoke 65.

The coil 61 is wound around the spool 62. An axis of the coil 61 extends in the front-rear direction (Y). The spool 62 includes a hole 621 extending in an axial direction of the coil 61. At least a part of the movable iron core 63 is arranged in the hole 621 of the spool 62. The movable iron core 63 is configured to move in the contact direction and the opening direction.

The movable iron core 63 is connected to the insulating member 17. The first movable contact piece 15 and the movable iron core 63 are electrically insulated by the insulating member 17. The second movable contact piece 16 and the movable iron core 63 are electrically insulated by the insulating member 17.

As illustrated in FIG. 3, the movable iron core 63 has a prismatic shape. The movable iron core 63 includes a plurality of plate members 631 and 632 that are provided separately from each other. In FIG. 3, only a part of the plurality of plate members is designated with a reference numeral, and the reference numerals of the other plate members are omitted. The plurality of plate members 631 and 632 are laminated and integrated with each other. For example, the plurality of plate members 631 and 632 are integrated by crimping. Alternatively, the plurality of plate members 631 and 632 may be integrated by welding.

The movable iron core 63 has a non-circular shape in a cross section perpendicular to the front-rear direction (Y). The movable iron core 63 has a polygonal shape in a cross section perpendicular to the front-rear direction (Y). For example, the movable iron core 63 has a quadrangular shape in a cross section perpendicular to the front-rear direction (Y). However, the shape of the cross section of the movable iron core is not limited to this, and may be changed.

As illustrated in FIG. 6, the link part 25 of the insulating member 17 includes a locking groove 59. As illustrated in FIG. 3, the movable iron core 63 includes a link part 66. The link part 66 of the movable iron core 63 is arranged in the locking groove 59 of the insulating member 17. As a result, the link part 66 is locked in the locking groove 59, so that the insulating member 17 is connected to the movable iron core 63.

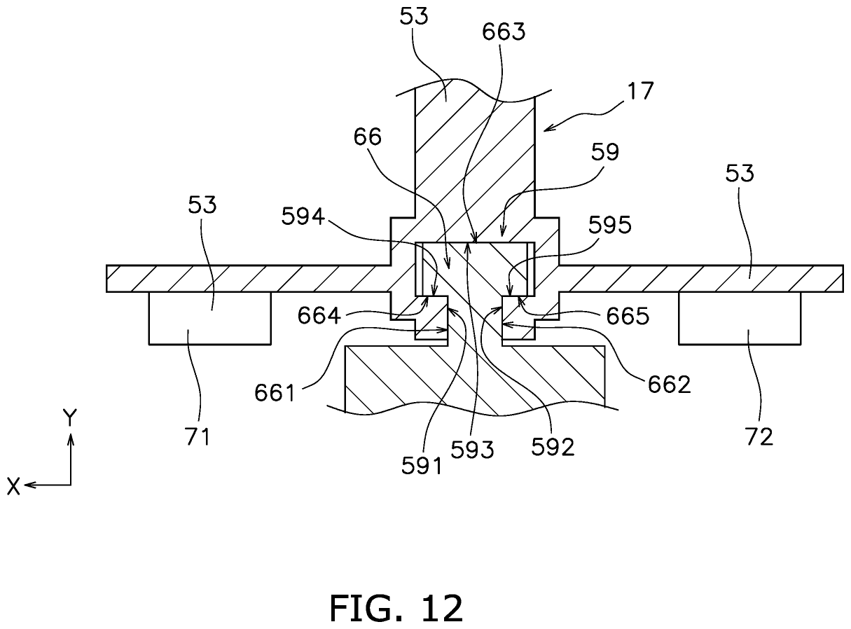

FIG. 12 is an enlarged cross-sectional view of the insulating member 17 and the movable iron core 63. As illustrated in FIG. 12, the locking groove 59 of the insulating member 17 includes a first flat surface 591 and a second flat surface 592. The first flat surface 591 and the second flat surface 592 extend in the front-rear direction (Y). The link part 66 of the movable iron core 63 includes a third flat surface 661 and a fourth flat surface 662. The third flat surface 661 and the fourth flat surface 662 extend in the front-rear direction (Y). The first flat surface 591 contacts the third flat surface 661. The second flat surface 592 contacts the fourth flat surface 662. As a result, the insulating member 17 is fixed to the movable iron core 63 so as to be non-rotatable relative to the movable iron core 63 around the axis extending in the moving direction of the first movable contact piece 15.

The locking groove 59 of the insulating member 17 includes a fifth flat surface 593 extending in the left-right direction (X). The movable iron core 63 includes a sixth flat surface 663 extending in the left-right direction (X). The fifth flat surface 593 contacts the sixth flat surface 663. Further, the locking groove 59 includes a first step part 594 and a second step part 595. The first step part 594 and the second step part 595 each have a flat shape. The movable iron core 63 includes a third step part 664 and a fourth step part 665. The third step part 664 and the fourth step part 665 each have a flat shape. The first step part 594 contacts the third step part 664.

The second step part 595 contacts the fourth step part 665. As a result, the insulating member 17 is fixed to the movable iron core 63 so as to be immovable relative to the movable iron core 63 in the moving direction of the first movable contact piece 15.

As illustrated in FIG. 10, the fixed iron core 64 is arranged in the hole 621 of the spool 62. The fixed iron core 64 is arranged to face the movable iron core 63 in the front-rear direction (Y). The coil 61 generates an electromagnetic force that moves the movable iron core 63 in the contact direction by being energized.

The yoke 65 is arranged so as to surround the coil 61. The yoke 65 is arranged on a magnetic circuit generated by the coil 61. The yoke 65 includes a first yoke 67 and a second yoke 68. The first yoke 67 extends in the front-rear direction (Y) and the left-right direction (X). The first yoke 67 faces the insulating member 17 in the front-rear direction (Y). A part of the second yoke 68 is arranged on the left side and the right side of the coil 61. The second yoke 68 is connected to the fixed iron core 64.

The relay 1 includes a first return spring 53 and a second return spring 54. The first return spring 53 and the second return spring 54 are arranged between the insulating member 17 and the drive device 4. That is, the first return spring 53 and the second return spring 54 are arranged outside the drive device 4.

Specifically, the first return spring 53 is arranged between the first connection part 43 and the first yoke 67. As illustrated in FIG. 6, the first connection part 43 includes the first spring connection part 71. The first spring connection part 71 protrudes from the first connection part 43. The first return spring 53 is connected to the first spring connection part 71.

The second return spring 54 is arranged between the second connection part 44 and the first yoke 67. As illustrated in FIG. 6, the second connection part 44 includes the second spring connection part 72. The second spring connection part 72 protrudes from the second connection part 44. The second return spring 54 is connected to the second spring connection part 72. The first return spring 53 and the second return spring 54 urge the movable iron core 63 in the opening direction.

Next, the operation of the relay 1 will be described. When the coil 61 is not energized, the drive device 4 is not magnetized. In this case, the insulating member 17 is pressed together with the movable iron core 63 in the opening direction by the elastic force of the return springs 53 and 54. Therefore, the insulating member 17 is located at an open position illustrated in FIG. 10. In this state, the first movable contact piece 15 and the second movable contact piece 16 are also pressed in the opening direction via the insulating member 17. Therefore, the insulating member 17 is located at the open position, and the first movable contact 31 and the second movable contact 32 are separated from the first fixed contact 21 and the second fixed contact 22. Similarly, the insulating member 17 is located at the open position, and the third movable contact 33 and the fourth movable contact 34 are separated from the third fixed contact 23 and the fourth fixed contact 24.

When the coil 61 is energized, the drive device 4 is magnetized. In this case, the movable iron core 63 moves in the contact direction by the electromagnetic force of the coil 61 against the elastic force of the return springs 53 and 54. As a result, the insulating member 17, the first movable contact piece 15, and the second movable contact piece 16 move in the contact direction. Therefore, as illustrated in FIG. 11, the insulating member 17 moves to a closed position. As a result, the insulating member 17 is located at the closed position, and the first movable contact 31 and the second movable contact 32 contact the first fixed contact 21 and the second fixed contact 22, respectively. Similarly, the insulating member 17 is located at the closed position, the third movable contact 33 and the fourth movable contact 34 contact the third fixed contact 23 and the fourth fixed contact 24, respectively. As a result, the first movable contact piece 15 and the second movable contact piece 16 are electrically connected in parallel with the first fixed terminal 13 and the second fixed terminal 14.

When the current to the coil 61 is stopped and degaussed, the movable iron core 63 is pressed in the opening direction by the elastic force of the return springs 53 and 54. As a result, the insulating member 17, the first movable contact piece 15, and the second movable contact piece 16 move in the opening direction. Therefore, as illustrated in FIG. 10, the insulating member 17 moves to the open position. As a result, the insulating member 17 is located at the open position, and the first movable contact 31 and the second movable contact 32 are separated from the first fixed contact 21 and the second fixed contact 22. Similarly, the insulating member 17 is located at the open position, the third movable contact 33 and the fourth movable contact 34 are separated from the third fixed contact 23 and the fourth fixed contact 24.

In the relay 1 according to the present embodiment described above, the first movable contact piece 15 and the movable iron core 63 are connected by the insulating member 17. Further, the first movable contact piece 15 and the movable iron core 63 are electrically insulated by the insulating member 17. Therefore, it is possible to secure an appropriate insulation distance for the first movable contact piece 15 while suppressing enlargement of the relay 1.

Although one embodiment of the present invention has been described above, the present invention is not limited to the above embodiment, and various modifications can be made without departing from the gist of the invention.

In the above embodiment, the drive device 4 pushes the insulating member 17 from the drive device 4 toward the contact device 2, so that the first movable contact piece 15 and the second movable contact piece 16 move in the opening direction. Further, when the drive device 4 pulls the insulating member 17 from the contact device 2 toward the drive device 4, the first movable contact piece 15 and the second movable contact piece 16 move in the contact direction. However, the operating direction of the insulating member 17 for opening and closing the contacts may be opposite to that of the above embodiment. That is, the drive device 4 may push the insulating member 17 from the drive device 4 toward the contact device 2, so that the first movable contact piece 15 and the second movable contact piece 16 may move in the contact direction. The drive device 4 may pull the insulating member 17 from the contact device 2 toward the drive device 4 so that the first movable contact piece 15 and the second movable contact piece 16 move in the opening direction. That is, the contact direction and the opening direction may be opposite to those of the above embodiment.

The shapes or arrangements of the first fixed terminal 13, the second fixed terminal 14, the first movable contact piece 15, and the second movable contact piece 16 may be changed. For example, the first outer terminal part 132 and the second outer terminal part 142 may protrude from the base 11 in a direction different from that of the above embodiment. The first movable contact piece 15 and the second movable contact piece 16 may be integrated. That is, the first to fourth movable contacts 31 to 34 may be connected to an integrated movable contact piece. Alternatively, the second movable contact piece 16, the third and fourth movable contacts 33 and 34, and the third and fourth fixed contacts 23 and 24 may be omitted.

The shapes or arrangements of the coil 61, the spool 62, the movable iron core 63, the fixed iron core 64, and the yoke 65 may be changed. The shapes or arrangements of the first to fourth fixed contacts 21 to 24 may be changed. The shapes or arrangements of the first to fourth movable contacts 31 to 34 may be changed.

The first fixed contact 21 and/or the third fixed contact 23 may be integrated with the first fixed terminal 13. The first fixed contact 21 and/or the third fixed contact 23 may be a part of the first fixed terminal 13 and may be flush with the other part of the first fixed terminal 13. The second fixed contact 22 and/or the fourth fixed contact 24 may be integrated with the second fixed terminal 14. The second fixed contact 22 and/or the fourth fixed contact 24 may be a part of the second fixed terminal 14 and may be flush with the other part of the second fixed terminal 14.

The first movable contact 31 and/or the second movable contact 32 may be integrated with the first movable contact piece 15. The first movable contact 31 and/or the second movable contact 32 may be a part of the first movable contact piece 15 and may be flush with the other part of the first movable contact piece 15. The third movable contact 33 and/or the fourth movable contact 34 may be integrated with the second movable contact piece 16. The third movable contact 33 and/or the fourth movable contact 34 may be a part of the second movable contact piece 16 and may be flush with the other part of the second movable contact piece 16.

The shape or arrangement of the insulating member 17 may be changed. The shape or arrangement of the base 11 may be changed. The shape or arrangement of the case 12 may be changed. The structures of the link part 25 of the insulating member 17 and the link part 66 of the movable iron core 63 may be changed. The first protrusion 46 and the second protrusion 47 may be provided at the upper end of the insulating member 17. Alternatively, protrusions similar to the first protrusion 46 and the second protrusion 47 may be additionally provided on the upper end of the insulating member 17.

In the above embodiment, the insulating member 17 is supported by the support protrusions 18 and 19 on the top surface of the case 12, and the first recess 55 and the second recess 56 of the base 11. However, the insulating member 17 may be supported by only one of the base 11 and the case 12. The support structure of the case 12 for the insulating member 17 may be changed. The support structure of the base 11 for the insulating member 17 may be changed. Alternatively, the insulating member 17 may not be supported by the housing 3.

The movable iron core 63 is not limited to a prismatic shape, and may have another shape such as a columnar shape. The movable iron core 63 is not limited to a plurality of plate members that are provided separately from each other, and may be integrally formed.

The number of return springs is not limited to two, and may be one or more than two. The arrangement of the return springs may be changed. For example, the return spring may be arranged in the hole 621 of the spool 62. The number of contact springs is not limited to two, and may be one or more than two. The arrangement of the contact springs may be changed.

### REFERENCE SIGNS LIST

3: Housing, 4: Drive Device, 13: First Fixed Terminal, 14: Second Fixed Terminal, 15: First Movable Contact Piece, 16: Second Movable Contact Piece, 17: Insulating Member, 21: First Fixed Contact, 22: Second Fixed Contact, 23: Third Fixed Contact, 24: Fourth Fixed Contact, 25: Link Part, 31: First Movable Contact, 32: Second Movable Contact, 33: Third Movable Contact, 34: Fourth Movable Contact, 43: First Connection Part, 44: Second Connection Part, 46: First Protrusion, 53: First Return Spring, 54: Second Return Spring, 55: First Recess, 61: Coil, 62: Spool, 63: Movable Iron Core, 591: First Flat Surface, 592: Second Flat Surface, 661: Third Flat Surface, 662: Fourth Flat Surface, 631,632: Plate Member

1. A relay comprising:
a first fixed terminal;
a first fixed contact connected to the first fixed terminal;
a second fixed terminal;
a second fixed contact connected to the second fixed terminal;
a first movable contact piece configured to move in a moving direction;
a first movable contact that faces the first fixed contact, the first movable contact being connected to the first movable contact piece;
a second movable contact that faces the second fixed contact, the second movable contact being connected to the first movable contact piece;
an insulating member connected to the first movable contact piece;
a drive device including a spool, a coil wound around the spool, and a movable iron core at least partially disposed in the spool and connected to the insulating member, the drive device being configured to move the movable iron core by a magnetic force generated from the coil to move the first movable contact piece,
the first movable contact piece and the movable iron core being electrically insulated by the insulating member.

2. The relay according to claim 1, wherein
the insulating member is fixed to the movable iron core so as to be immovable relative to the movable iron core in the moving direction of the first movable contact piece.

3. The relay according to claim 1, wherein
the insulating member is fixed to the movable iron core so as to be non-rotatable relative to the movable iron core around an axis extending in the moving direction of the first movable contact piece.

4. The relay according to claim 1, wherein
the insulating member includes a first flat surface and a second flat surface extending in the moving direction of the first movable contact piece,
the movable iron core includes a third flat surface and a fourth flat surface extending in the moving direction of the first movable contact piece,
the first flat surface contacts the third flat surface, and
the second flat surface contacts the fourth flat surface.

5. The relay according to claim 1, wherein
the movable iron core includes a plurality of plate members provided separately from each other.

6. The relay according to claim 5, wherein
the plurality of plate members are laminated and integrated with each other.

7. The relay according to claim 1, wherein
the movable iron core has a non-circular shape in a cross section perpendicular to the moving direction of the first movable contact piece.

8. The relay according to claim 1, wherein
the movable iron core has a prismatic shape.

9. The relay according to claim 1, further comprising:
a housing configured to slidably support the insulating member.

10. The relay according to claim 9, wherein
the insulating member includes a protrusion protruding toward the housing, and
the housing is further configured to slidably support the insulating member at the protrusion.

11. The relay according to claim 10, wherein
the housing includes a recess configured to contact the protrusion.

12. The relay according to claim 9, wherein
the housing includes a base configured to support the drive device, and
the base is further configured to slidably support the insulating member.

13. The relay according to claim 1, further comprising:
a first return spring configured to contact the insulating member; and
a second return spring configured to contact the insulating member, wherein
the moving direction includes an opening direction in which the first movable contact and the second movable contact move away from the first fixed contact and the second fixed contact,
the first return spring is further configured to press the insulating member in the opening direction, and
the second return spring is further configured to press the insulating member in the opening direction.

14. The relay according to claim 13, wherein
the insulating member includes
a link part connected to the movable iron core,
a first connection part connected to the link part and to which the first return spring is connected, and
a second connection part connected to the link part and to which the second return spring is connected.

15. The relay according to claim 1, further comprising:
a third fixed contact connected to the first fixed terminal;
a fourth fixed contact connected to the second fixed terminal;
a second movable contact piece provided separately from the first movable contact piece;
a third movable contact that faces the third fixed contact, the third movable contact being connected to the second movable contact piece; and
a fourth movable contact that faces the fourth fixed contact, the fourth movable contact being connected to the second movable contact piece, wherein
the insulating member is connected to the first movable contact piece and the second movable contact piece,
the first movable contact piece and the movable iron core are electrically insulated by the insulating member, and
the second movable contact piece and the movable iron core are electrically insulated by the insulating member.
